(19) United States
(12) Patent Application Publication
(10) Pub. No.: US 2025/0027584 A1
(43) Pub. Date: Jan. 23, 2025

(54) Expandable and Contractable Hose

(71) Applicant: Synergy Shipping Solutions, LLC, Buda, TX (US)

(72) Inventor: Christopher Wilson, Buda, TX (US)

(21) Appl. No.: 18/355,096

(22) Filed: Jul. 19, 2023

(51) Int. Cl. F16L 11/12; F16L 11/08

(52) U.S. Cl. CPC F16L 11/12; F16L 11/086

(57) ABSTRACT

A hose for directing a flow of liquid from a source of pressurized liquid has an outer tube and an inner tube each having a first end and a second end. The outer tube can stretch from an inner length and diameter to a maximum length and diameter, and the inner tube is within the outer tube and is formed of an elastic material that stretches from a first length and diameter to a second length and diameter. Expansion of the inner tube upon receiving the flow of liquid expands the outer tube to the maximum length and diameter. A proximal coupler is secured to the first ends and is constructed to couple the hose to the source of pressurized liquid. A coil spring is positioned within the inner tube adjacent the proximal coupler, the coil spring having a diameter that is large enough to bias the inner tube outwardly.

### BACKGROUND OF THE INVENTION

### Field of the Invention

This invention relates generally to hoses, and more particularly to a hose that is expandable when in use, and contractable when not in use, and which is resistant to kinking.

### Description of Related Art

Standard garden hoses are typically constructed of rubber, rubber hybrids, soft plastics, or vinyl, often reinforced with an internal web or fibers. These materials are generally used with the intention of maintaining flexibility at different contrasting temperatures. However, rubber is generally heavy to lift, and a problem with standard garden hoses is that they are of fixed length and diameter, and therefore bulky to store and cumbersome to use. They are also prone to kink because, while they are constructed to maintain their tubular shape, the weight of the hose can force the hose to bend and eventually kink when a user pulls the hose during ordinary use.

A new form of hose which is expandable and contractable is disclosed in Berardi, U.S. Pat. No. 10,174,870, which teaches a hose that automatically expands longitudinally and automatically expands laterally upon the application of a pressurized liquid. The hose can automatically expand longitudinally up to six times its unexpanded or contracted length. Upon release of the pressurized liquid within the hose, the hose will automatically contract to the contracted condition. The hose includes an inner tube made from an elastic material and an outer tube made from a non-elastic material. The inner tube is positioned concentrically within the outer tube in both a contracted condition and an expanded condition. The outer tube is secured to the inner tube only at a first end of the inner and outer tubes and at a second end of the inner and outer tubes. The outer tube moves laterally and longitudinally with respect to the inner tube when the tubes are transitioning between a contracted condition and an expanded condition.

A problem with an expandable and contractable hose is that this hose also tends to kink, especially adjacent the connector that connects the hose to a spigot or other water source. The present invention overcomes this problem, and meets a long felt need in the industry, for a hose that is resistant to kinks, by providing a coil spring adjacent the connector that is used to attach the hose to the spigot. Importantly, the coil spring is positioned within an inner tube of the hose, and biases the inner tube outwardly against an outer tube of the hose.

### SUMMARY OF THE INVENTION

The present invention teaches certain benefits in construction and use which give rise to the objectives described below.

The present invention provides a hose that includes an outer tube having a first end and a second end, the outer tube being capable of stretching from an initial length and initial diameter, to a maximum length and a maximum diameter, and an inner tube having a first end and a second end, the inner tube being formed of an elastic material that stretches from a first length and a first diameter to a second length and a second diameter. The inner tube is positioned within the outer tube such that expansion of the inner tube upon receiving the flow of liquid expands the outer tube to the maximum length and diameter. A proximal coupler is secured to the first ends of the inner tube and the outer tube, and is constructed to couple the hose to the source of pressurized liquid. A coil spring is positioned within the inner tube adjacent the proximal coupler, the coil spring having a diameter that is large enough to bias the inner tube outwardly such that the inner tube is held in frictional contact with the outer tube. A flow restrictor is operably positioned in or adjacent to the distal nozzle, such that upon introduction of a flow of liquid through the proximal coupler into the inner tube, the inner tube fills with the liquid resulting in an increase in fluid pressure within the inner tube, the increase in fluid pressure expands the inner tube longitudinally along a length of the inner tube and laterally across a width of the inner tube thereby increasing the length of the hose.

A primary objective of the present invention is to provide a hose having advantages not taught by the prior art.

Another objective of the present invention to provide a hose that includes a coil spring adjacent a proximal coupler that biases an inner tube outwardly against an outer tube so that they are frictionally engaged to prevent kinking adjacent the proximal coupler and to enable correct expansion of the hose when a flow of liquid is introduced.

Another objective of the present invention to provide a hose that expands longitudinally and expands laterally upon the application of a pressurized liquid within the hose.

It is a further objective of the present invention to provide a hose that automatically contracts upon release of a pressurized liquid within the hose. The contracted length being up to six times shorter that an expanded length.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention.

FIG. 1 is a perspective view of a proximal end of a hose according to one embodiment of the present invention.

FIG. 2 is a sectional view thereof taken along line 2-2 in FIG. 1, illustrating the proximal end of the hose in a deflated condition.

FIG. 3 is a sectional view thereof taken along line 2-2 in FIG. 1, illustrating the proximal end of the hose in an inflated condition.

FIG. 4 is a perspective view of a distal end of the hose of FIG. 1.

FIG. 5 is an exploded perspective view of the distal end of the hose of FIG. 4.

### DETAILED DESCRIPTION OF THE INVENTION

The above-described drawing figures illustrate the invention, a hose for directing a flow of liquid from a source of pressurized liquid, the hose being capable of expanding from a deflated condition to an inflated condition. As discussed in greater detail below, the hose includes a coil spring adjacent a proximal coupler that biases an inner tube outwardly against an outer tube so that they are frictionally engaged to prevent kinking adjacent the proximal coupler and to enable correct expansion of the hose when the flow of liquid is introduced.

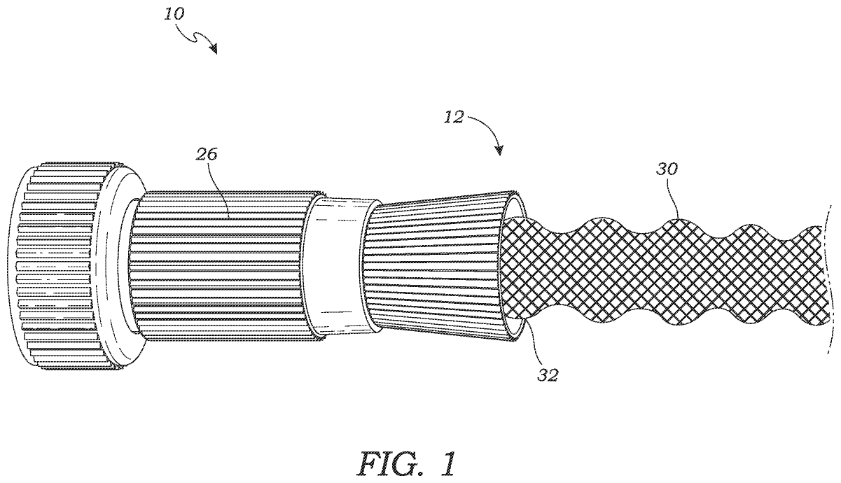

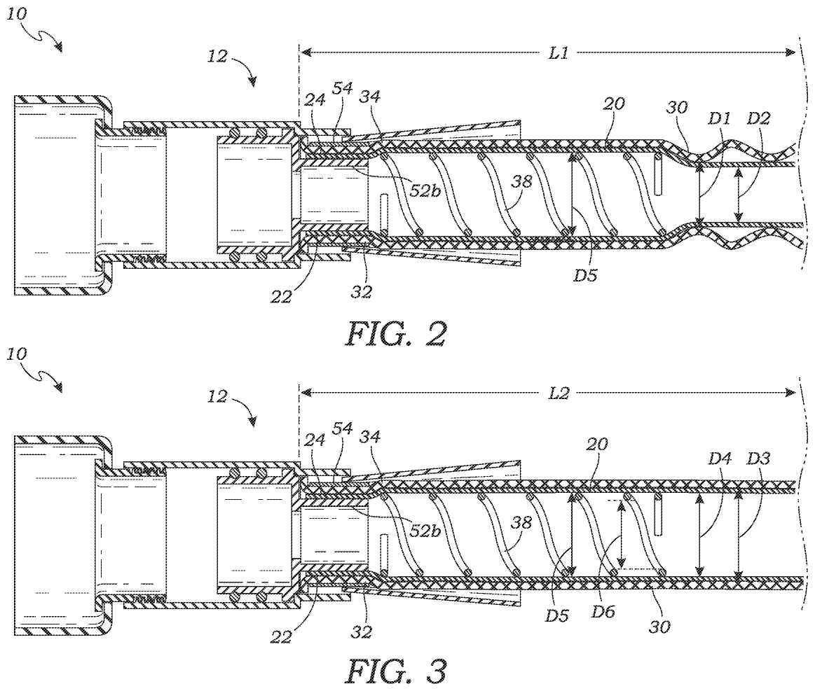

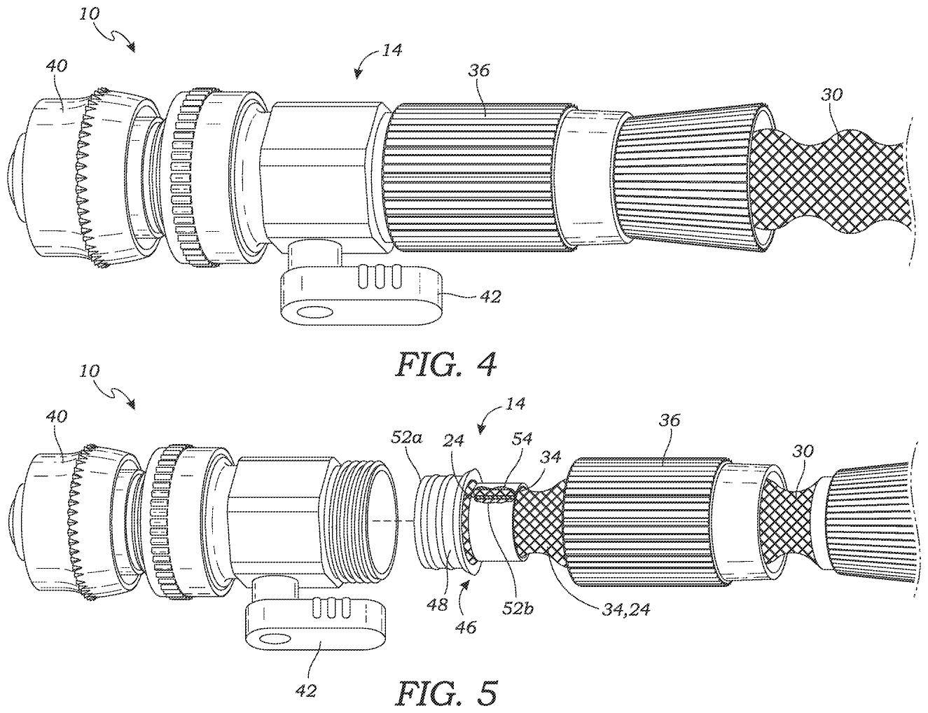

FIG. 1 is a perspective view of a proximal end 12 of a hose 10 according to one embodiment of the present invention. FIG. 2 is a sectional view thereof taken along line 2-2 in FIG. 1, illustrating the proximal end 12 of the hose 10 in a deflated condition, and FIG. 3 is a sectional view similar to FIG. 2, illustrating the proximal end 12 of the hose 10 in an inflated condition. As illustrated in FIGS. 1-3, the hose 10 comprises an inner tube 20 positioned within an outer tube 30, each tube having a first end 22 and 32, and a second end 24 and 34, respectively, the second ends 24 and 34 being shown in FIGS. 4-5.

A proximal coupler 26 is secured to the first ends 22 and 32, the proximal coupler 26 being constructed to couple the hose 10 to a source of pressurized liquid (not shown) such as a faucet or a water outlet on the exterior or interior of a house or residence; most water faucets on homes or residences are provided with a standard size coupler or fitting, though of course custom sizes are possible. Furthermore, a distal nozzle 36 (shown in FIGS. 4-5) is operably connected to the second ends 24 and 34, wherein the hose 10 is adapted to direct a flow of liquid from the source of pressurized liquid and out of the distal nozzle 36. The inner and outer tubes 20 and 30 and the proximal and distal nozzles 26 and 36 are each described in detail below.

As shown in FIGS. 1-3, the hose 10 is disposed on a central axis, and the outer tube 30 is capable of stretching from an initial length L1 and initial diameter D1, to a maximum length L2 and a maximum diameter D3 relative to the central axis A. The inner tube 20 is formed of an elastic material that stretches from a first length L1 and a first diameter D2 to a second length L2 and a second diameter D4. The inner tube 20 is positioned within the outer tube 30 such that expansion of the inner tube 20 upon receiving the flow of liquid expands the outer tube 30 from the initial length L1 and first diameter D1 to the maximum length L2 and maximum diameter D3. While the constraints of the drawings necessitate a partial line showing the lengths L1 and L2, obviously, these lengths are intended to denote the entirety of the hose 10. In some embodiments, the maximum length L2 of the outer tube 30 is at least 45feet, but any suitable length may be manufactured, according to the needs of the consumer.

The inner tube 20 is formed from a material that is elastic, and may have an elongation ratio of up to 6 to 1, expanding up to 4 to 6 times its relaxed or unexpanded length when a pressurized liquid is introduced into the inner tube 20. One material for the inner tube 20 is latex rubber. However, other synthetic materials, which have elastic properties similar to latex rubber, specifically, the ability to automatically retract from a stretched or expanded state, can also be used. Upon application of pressurized liquid into the inner tube 20, the inner tube 20 expands radially outwardly or laterally, with respect to its length, within the outer tube 30. The radial expansion of the inner tube 20 may be constrained by the maximum diameter D3 of the outer tube 30. The outer tube 30 may be formed from a non-elastic, relatively soft, bendable, tubular webbing material, such as braided or woven nylon, polyester, polypropylene, etc. or any other materials compatible with the outer tube 30 as claimed herein. Preferably, the outer tube 30 is bendable and strong enough to withstand internal pressures of up to 250 pounds per square inch, (psi).

As shown in FIGS. 2-3, a coil spring 38 is positioned within the inner tube 20 adjacent the proximal coupler 26, the coil spring 38 having a length of at least 1 inch, typically around 2-10 inches, and is substantially shorter (10% or less) than the initial length L1 of the outer tube 30. The coil spring 38 has an outer diameter D5 that is approximately equal the maximum diameter D3 of the outer tube 30. For purposes of this application, the term “approximately” is defined to mean that it is large enough to bias the inner tube 20 outwardly against the outer tube 30, and the inner tube 20 is held in frictional contact with the outer tube 30 and the outer tube 30 is stretched to within 10% of the maximum diameter, allowing sufficient tolerances that may be determined by one skilled in the art to facilitate assembly of the hose 10.

In some embodiments, the length of the coil spring 38 is between approximately 1-6inches, and the maximum length of the outer tube 30 is at least 10 feet. In some embodiments, the diameter of the coil spring 38 is approximately ⅜-¾ inch. Obviously, other lengths may be implemented, as devised by one skilled in the art. The implementation of the coil spring 38 may, in some uses, aid in allowing expansion of the hose 10 without an initial restriction upon introduction of the flow of liquid.

As noted above, the coil spring 38 and the compression of the inner tube 20 against the outer tube 30, functions to prevent kinking of the hose 10 in this location, a location that is particularly susceptible to kinks, which would prevent proper inflation of the hose 10.

FIG. 4 is a perspective view of a distal end 14 of the hose 10 of FIG. 1. FIG. 5 is an exploded perspective view of the distal end 14 of the hose 10 of FIG. 4. As shown in FIGS. 4-5, second ends 24 and 34 of the inner tube 20 and the outer tube 30, respectively, are connected with a flow restrictor 46, in this case by a fastener 54 that secures the second ends 24 and 34 and clamps them against a tubular output 52a of the flow restrictor 46. The flow restrictor 46 is sized and shaped to restrict the flow of the fluid out of the hose 10, so that pressure from the fluid source builds up and inflates the hose 10.

As shown in FIG. 5, a distal nozzle 36 is provided downstream of the flow restrictor 46. The distal nozzle 36 may be in the form of a nozzle operably positioned in or adjacent to the distal nozzle 36, such that upon introduction of the flow of liquid through the proximal coupler 26 into the inner tube 20, the inner tube 20 fills with the liquid resulting in an increase in fluid pressure within the inner tube 20, the increase in fluid pressure expands the inner tube 20 longitudinally along a length of the inner tube 20 and laterally across a width of the inner tube 20 thereby increasing the length of the hose 10. In this embodiment, the flow restrictor 46 includes an inner conduit (not shown) between an output end 52a and an input end 52b, wherein the input end 52b is operably attached to the second ends 24 and 34 of the inner and outer tubes 20 and 30, and the inner conduit is a smaller diameter than the diameter of the input, to limit the flow of liquid flowing out, and building up pressure within the hose 10. As illustrated in

FIG. 5, the flow restrictor 46 may additionally comprise a fastening band 54 at the input end 52b, the fastening band 54 being secured around the inner tube 20 and the outer tube 30 so they are fastened to the flow restrictor 46. In some embodiments, the flow restrictor 46 further includes a flange 56 between the input end 52b and the output end 52a, which may prevent the flow restrictor 46 from being pulled all the way through the distal nozzle 36.

A nozzle 40 or other distributor can also be secured to the distal nozzle 36 end of hose 10, which may be in the form of a conventional nozzle that varies the rate and spray pattern of water exiting therefrom. Many alternative nozzles are L-shaped so as to be able to be comfortably gripped and used by an individual, which should be considered within the scope of the present invention. The nozzle 40 may also have a pivoting on-off handle 42 which operates an internal valve (not shown). This internal valve permits, limits, and stops the flow of water through the nozzle 40, to generate a build-up of liquid within the hose 10 between the two couplers 26 and 36. The nozzle 40 may provide various amounts of restriction to the liquid exiting at the end of the hose 10, by opening or restricting the opening in the nozzle 40. The smaller the opening in the nozzle 40, the more the nozzle 40 restricts the release of liquid at the end of the hose 10, and the higher the pressure and volume of liquid inside the hose 10. The larger the opening in the nozzle 40, the less the nozzle 40 restricts the release of liquid at the end of the hose 10, and the lower the pressure and volume of liquid inside the hose 10. Since these types of nozzles are well-known in the art, specific structures are not further elaborated herein. It should be understood that any suitable nozzle may be attached to the hose 10, and the hose 10 may be adapted to fit a wide range of standard or custom nozzles.

In use, the hose 10 is self-expanding upon a supply of a pressurized liquid into the hose 10. The hose 10 is also self-contracting upon release of the pressurized liquid and fluid volume from within the hose 10. In some embodiments of the present invention the hose 10 expands up to 4 to 6 times its contracted length during operation. Thus, a ten-foot hose in a contracted condition would expand up to 40 to 60 feet when liquid under pressure is supplied into the inner tube 20 of the hose 10. The pressure within the hose 10 is accomplished by introducing liquid under pressure into one end of the hose 10 and restricting the flow of the liquid out of the other end of the hose 10, resulting in the liquid filing up and expanding the inner tube 20. For example, when the hose 10 of the present invention is utilized as a garden hose around a house, the proximal coupler 26 is secured to a faucet or water outlet on an exterior wall of the house. The faucet is turned on or opened so that water under pressure can now enter the hose 10. A relatively normal pressure for water within a house is 60 psi. However, the pressure of water within a hose can vary widely, depending on a number of circumstances, such as the pressure of water supplied by a water utility, the pressure of water supplied by a pump and sustained by an air bladder, when water is supplied from a well, etc.

The pressure coming from a typical house is approximately 60 psi. If the flow of liquid was totally restricted at the proximal end 12 of the hose 10, the psi inside the inner tube 20 would be the same as the pressure coming from the house, 60 psi. At this high pressure, the inner tube 20 and the outer tube 30 in the present invention would expand to its maximum length. As the liquid at the distal end of the hose 10 is released, the internal pressure is maintained by the flow restrictor. In one embodiment, the hose 10 expands from ten feet in length in its contracted condition to fifty feet in length in its expanded condition.

Another feature of the present invention is that the outer tube 30 is reduced or decreased in length when there is no pressure within inner tube 20. With no pressure or volume in the inner tube 20, it automatically contracts.

The main embodiment of the present invention utilizes water to fill and expand the hose 10. However, other liquids can also be employed with the present invention, so long as the liquids are not corrosive to the inner tube 20. The temperatures of the liquids employed in the present invention are lower than temperatures which will alter the physical and chemical properties of the materials used in the hose 10 of the present invention. Also, because the inner tube 20 is elastic it can expand if the water within the tube freezes. For example, of a garden hose of the present invention were left outside in the winter, the water contained therein would freeze. Normal garden hoses would split, but the present invention would expand when the water turns to ice because the inner tube 20 is elastic. In most implementations, the hose 10 may be used as a garden hose, but the hose 10 may be used in other fields, e.g., as a fire hose used by firefighters, or any other field in which such a hose may be useful.

The title of the present application, and the claims presented, do not limit what may be claimed in the future, based upon and supported by the present application. Furthermore, any features shown in any of the drawings may be combined with any features from any other drawings to form an invention which may be claimed.

As used in this application, the words “a,” “an,” and “one” are defined to include one or more of the referenced item(s) unless specifically stated otherwise. The terms “approximately” and “about” are defined to mean +/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

What is claimed is:

1. A hose comprising:
an outer tube having a first end and a second end, the outer tube being capable of stretching from an initial length and initial diameter, to a maximum length and a maximum diameter;
an inner tube having a first end and a second end;
a proximal coupler secured to the first ends of the inner tube and the outer tube;
a coil spring positioned within the inner tube adjacent the proximal coupler, the coil spring having a diameter that is large enough to bias the inner tube outwardly such that the inner tube is held in frictional contact with the outer tube; and
a flow restrictor connected to the second end of the inner tube and the second end of the outer tube.

2. The hose of claim 1, further comprising a distal nozzle configured to receive fluid flowing from the flow restrictor.

3. The hose of claim 1, wherein the length of the coil spring is 1-6 inches and the maximum length of the outer tube is at least 10 feet.

4. The hose of claim 1, wherein the diameter of the coil spring is approximately ⅜-¾ inch.

5. The hose of claim 1, wherein the outer tube is constructed from a fabric material.

6. The hose of claim 1. wherein the inner tube is constructed from a material selected from a group consisting of nylon, polyester, or polypropylene.

7. The hose of claim 1, wherein the maximum length of the outer tube is at least 45 feet.

8. A hose for directing a flow of liquid from a source of pressurized liquid, the hose comprising:
an outer tube having a first end and a second end, the outer tube being capable of stretching from an initial length and initial diameter, to a maximum length and a maximum diameter;
an inner tube having a first end and a second end, the inner tube being formed of an elastic material that stretches from a first length and a first diameter to a second length and a second diameter;
the inner tube being positioned within the outer tube such that expansion of the inner tube upon receiving the flow of liquid expands the outer tube to the maximum length and diameter;
a proximal coupler secured to the first ends of the inner tube and the outer tube, the proximal coupler constructed to couple the hose to the source of pressurized liquid;
a coil spring positioned within the inner tube adjacent the proximal coupler, the coil spring having a diameter that is large enough to bias the inner tube outwardly such that the inner tube is held in frictional contact with the outer tube and the outer tube is stretched to approximately the maximum diameter;
a flow restrictor connected to the second end of the inner tube and the second end of the outer tube, such that upon introduction of the flow of liquid through the proximal coupler into the inner tube, the inner tube fills with the liquid resulting in an increase in fluid pressure within the inner tube, the increase in fluid pressure expands the inner tube longitudinally along a length of the inner tube and laterally across a width of the inner tube thereby increasing the length of the hose.

9. The hose of claim 8, further comprising a distal nozzle configured to receive fluid flowing from the flow restrictor.

10. The hose of claim 8, wherein the length of the coil spring is 1-6 inches and the maximum length of the outer tube is at least 10 feet.

11. The hose of claim 8, wherein the diameter of the coil spring is approximately ⅜-¾ inch.

12. The hose of claim 8, wherein the outer tube is constructed from a fabric material.

13. The hose of claim 8, wherein the inner tube is constructed from a material selected from a group consisting of nylon, polyester, or polypropylene.

14. The hose of claim 8, wherein the maximum length of the outer tube is at least 45 feet.
